(19) United States
(12) Patent Application Publication
(10) Pub. No.: US 2024/0385475 A1
(43) Pub. Date: Nov. 21, 2024

(54) OPTICAL SHEET LAMINATE, BACKLIGHT UNIT, LIQUID CRYSTAL DISPLAY DEVICE, INFORMATION EQUIPMENT, AND PRODUCTION METHOD FOR OPTICAL SHEET LAMINATE

(71) Applicant: KEIWA Incorporated, Tokyo (JP)

(72) Inventors: Satoshi UEJI, Tokyo (JP); Yu KARIYA, Tokyo (JP); Satoshi SHIBA, Tokyo (JP)

(21) Appl. No.: 18/665,308

(22) Filed: May 15, 2024

Related U.S. Application Data
(63) Continuation of application No. PCT/JP2022/041400, filed on Nov. 7, 2022.

(30) Foreign Application Priority Data
Nov. 18, 2021 (JP) 2021-187488

(51) Int. Cl. G02F 1/1335; G02F 1/13357

(52) U.S. Cl. CPC G02F 1/133507; G02F 1/133553; G02F 1/133603

(57) ABSTRACT

An optical sheet laminate 100 is built in a liquid crystal display device including a display screen, on a back surface side of which a plurality of point light sources 42 are provided in a dispersed manner. The optical sheet laminate 100 includes a first optical sheet 43 having a first surface 21b on which a first print pattern 101A at least partially reducing transmission of light from the plurality of point light sources 42 is formed. A second print pattern 101B at least partially reducing transmission of light from the plurality of point light sources 42 is formed on a second optical sheet 43 different from the first optical sheet 43 or on a second surface 21a of the first optical sheet 43. The first print pattern 101A and the second print pattern 101B reduce luminance unevenness attributed to the plurality of point light sources 42, thereby making the luminance uniform.

### CROSS REFERENCE TO RELATED APPLICATIONS

This application is a bypass continuation of International Application No. PCT/JP2022/041400, filed Nov. 7, 2022, which international application claims priority to and the benefit of Japanese Application No. 2021-187488, filed Nov. 18, 2021; the contents of both of which are hereby incorporated by reference herein in their respective entireties.

### BACKGROUND

The present disclosure relates to an optical sheet laminate, a backlight unit, a liquid crystal display device, an information equipment, and a production method for the optical sheet laminate.

Liquid crystal display devices have been widely used as display devices for various information equipment such as smartphones and tablet terminals. A major type of a backlight of a liquid crystal display device is a direct type in which light sources are arranged on the back surface of the liquid crystal panel.

When the direct type backlight is adopted, a light diffusion member (a light diffusion plate, a light diffusion sheet, or a light diffusion film) is used to avoid making the light sources themselves such as light emitting diodes (LEDs) traceable through a light-emitting surface and improve uniformity of in-plane luminance.

In Japanese Unexamined Patent Publication No. 2012-163785, in order to resolve the luminance unevenness of the optical sheet where a region directly above light sources has high luminance and a region between light sources has low luminance, a white ink printing is performed on the region directly above the light sources and having high luminance so that the light transmission is reduced. Accordingly, the luminance uniformity of the optical sheet is improved.

### SUMMARY

However, a conventional optical sheet is provided with a print pattern according to a luminance distribution (luminance unevenness) in order to improve the luminance uniformity. Thus, when the position of the print pattern is misaligned with respect to the arrangement positions of the light sources, the luminance uniformity is lowered.

It is an object of the present disclosure to improve the luminance uniformity of a direct type backlight unit.

An optical sheet laminate of the present disclosure is an optical sheet laminate built in a liquid crystal display device including a display screen, on a back surface side of which a plurality of point light sources are provided in a dispersed manner. The optical sheet laminate includes a first optical sheet having a first surface on which a first print pattern at least partially reducing transmission of light from the plurality of point light sources is formed. A second print pattern at least partially reducing transmission of light from the plurality of point light sources is formed on a second optical sheet different from the first optical sheet or on a second surface of the first optical sheet. The first print pattern and the second print pattern reduce luminance unevenness attributed to the plurality of point light sources, thereby making the luminance uniform.

In the optical sheet laminate of the present disclosure, the first and second print patterns that reduce luminance unevenness are arranged on a plurality of different optical sheets, respectively, or on both surfaces of a single optical sheet. Thus, an amount of changes (tone changes) in the print density in the first and second print patterns can be smaller than when a single print pattern is used to reduce luminance unevenness. Thus, the luminance uniformity can be less reduced even when the position of the first print pattern and/or the second print pattern is/are misaligned with respect to the arrangement positions of the light sources.

In the optical sheet laminate of the present disclosure, the first print pattern and the second print pattern may be each a collection of unit patterns arranged in a gradation manner so that a level of reduction in light transmission decreases from a vicinity of a portion directly above one single point light source out of the plurality of point light sources toward an intermediate region between the one single point light source and another point light source adjacent to the one single point light source, and the unit patterns are arranged two-dimensionally without uneven distribution to serve as the first print pattern and the second print pattern. Alternatively, at least one of the first print pattern or the second print patterns may be a pattern having a print density corresponding to luminance in a luminance distribution produced by the plurality of point light sources when the first print pattern and the second print pattern are not provided, and the luminance and the print density may have a positive correlation with each other. Alternatively, a pattern formed by stacking the first print pattern and the second print patterns may be a pattern having a print density corresponding to the luminance in a luminance distribution produced by the plurality of point light sources when the first print pattern and the second print pattern are not provided, and the luminance and the print density may have a positive correlation with each other. In this way, the first and second print patterns reduce luminance unevenness attributed to the plurality of point light sources, thereby improving the luminance uniformity. In this case, the high luminance region in the luminance distribution may be a region directly above the plurality of point light sources or a region between the point light sources adjacent to each other out of the plurality of point light sources, depending on the configuration of the optical sheet laminate, the characteristics of the point light sources, and the like. In this way, the luminance is reduced in a region directly above the point light source or in a region between the point light sources, and the luminance uniformity can be improved.

In the optical sheet laminate of the present disclosure, the first optical sheet may be a first light diffusion sheet. In this way, the first light diffusion sheet can further reduce luminance unevenness. In this case, when the second print pattern is formed on the second optical sheet; in the first light diffusion sheet, the first surface is a flat surface or a matte surface; the second surface is provided with a plurality of recesses arranged two-dimensionally; and the second optical sheet is a second light diffusion sheet having a flat surface or a matte surface on which the second print pattern is formed, it is easy to form the first and second print patterns on a flat surface or a matte surface having small unevenness. Alternatively, when the second print pattern is formed on the first light diffusion sheet; in the first light diffusion sheet, one surface out of the first surface and the second surface is provided with a plurality of recesses arranged two-dimensionally; and the other surface out of the first surface and the second surface is a flat surface or a matte surface, the first print pattern or the second print pattern is stuffed into the recesses to get thick, and thus the light transmission can be more reduced. The plurality of recesses may have an inverted polygon pyramid shape, an inverted truncated polygon pyramid shape, or a lower hemisphere shape. In this way, the light diffusion property of the light diffusion sheet can be improved.

A backlight unit of the present disclosure is a backlight unit built in the liquid crystal display device and leading light emitted from the plurality of point light sources toward the display screen. The backlight unit includes the optical sheet laminate of the present disclosure between the display screen and the plurality of point light sources.

The backlight unit of the present disclosure includes the optical sheet laminate of the present disclosure, and thus the luminance uniformity can be improved.

In the backlight unit of the present disclosure, a distance between the plurality of point light sources and the optical sheet laminate may be 2 mm or less. In this way, the luminance uniformity can be improved even in a configuration where the luminance unevenness is likely to appear in a conventional configuration.

In the backlight unit of the present disclosure, the plurality of point light sources may be LED elements. In this way, even when the number of light sources is reduced, the luminance on the entire display screen can be obtained sufficiently.

In the backlight unit of the present disclosure, the plurality of point light sources may be arranged on a reflection member provided on an opposite side of the display screen when viewed from the optical sheet laminate. In this way, the luminance uniformity can be more improved.

A liquid crystal display device of the present disclosure includes the backlight unit of the present disclosure and a liquid crystal display panel.

The liquid crystal display device of the present disclosure includes the backlight unit of the present disclosure, and thus the luminance uniformity can be improved.

An information equipment of the present disclosure includes the liquid crystal display device of the present disclosure.

The information equipment of the present disclosure includes the liquid crystal display device of the present disclosure, and thus, the luminance uniformity can be improved.

A production method of the present disclosure for an optical sheet laminate is a production method for an optical sheet laminate built in a liquid crystal display device including a display screen, on a back surface side of which a plurality of point light sources are provided in a dispersed manner. The production method of the present disclosure for an optical sheet laminate includes: a step A of forming a first print pattern at least partially reducing transmission of light from the plurality of point light sources, on a first surface of a first optical sheet; and a step B of forming a second print pattern at least partially reducing transmission of light from the plurality of point light sources, on a second optical sheet different from the first optical sheet or on a second surface of the first optical sheet. The step A and the step B are performed so that the first print pattern and the second print pattern reduce luminance unevenness attributed to the plurality of point light sources, thereby making the luminance uniform.

According to the production method of the present disclosure for the optical sheet laminate, the first and second print patterns that reduce luminance unevenness are formed on a plurality of different optical sheets or on both surfaces of a single optical sheet. Thus, tone changes in the first and second print patterns can be smaller than when a single print pattern is used to reduce luminance unevenness. Thus, the luminance uniformity can be less reduced even when the position of the first print pattern and/or the second print pattern is/are misaligned with respect to the arrangement positions of the light sources.

In the production method of the present disclosure for an optical sheet laminate, the first print pattern and the second print pattern may be each a collection of unit patterns arranged in a gradation manner so that a level of reduction in light transmission decreases from a vicinity of a portion directly above one single point light source out of the plurality of point light sources toward an intermediate region between the one single point light source and another point light source adjacent to the one single point light source, and the unit patterns may be arranged two-dimensionally without uneven distribution to serve as the first print pattern and the second print pattern. Alternatively, at least one of the first print pattern or the second print pattern may be a pattern having a print density corresponding to the luminance in a luminance distribution produced by the plurality of point light sources when the first print pattern and the second print pattern are not provided, and the luminance and the print density may have a positive correlation with each other. Alternatively, a pattern formed by stacking the first print pattern and the second print patterns may be a pattern having a print density corresponding to the luminance in a luminance distribution produced by the plurality of point light sources when the first print pattern and the second print pattern are not provided, and the luminance and the print density may have a positive correlation with each other. In this way, the first and second print patterns reduce luminance unevenness attributed to the plurality of point light sources, thereby improving the luminance uniformity. In this case, the high luminance region in the luminance distribution may be a region directly above the plurality of point light sources or a region between the point light sources adjacent to each other out of the plurality of point light sources, depending on the configuration of the optical sheet laminate, the characteristics of the point light sources, and the like. In this way, the luminance is reduced in a region directly above the point light source or in a region between the point light sources, and the luminance uniformity can be improved.

The present disclosure enables improvement in the luminance uniformity of a direct type backlight.

### BRIEF DESCRIPTION OF THE DRAWINGS

FIG. 1 is a cross-sectional view of a liquid crystal display device of an embodiment.

FIG. 2 is a cross-sectional view of a backlight unit of the embodiment.

FIG. 3 is a cross-sectional view of a light diffusion sheet of the embodiment.

FIG. 4 is a perspective view of a light diffusion sheet of the embodiment.

FIG. 5 is a cross-sectional view showing how a print pattern is formed on one surface of a light diffusion sheet of Comparative Example.

FIG. 6 is a plan view of a print pattern formed on the light diffusion sheet of Comparative Example.

FIG. 7 shows a relationship between the print pattern on the light diffusion sheet of Comparative Example and the arrangement of point light sources.

FIG. 8A-8D are schematic diagrams showing that the position of the print pattern is misaligned in Comparative Example.

FIG. 9 is a cross-sectional view showing that a print pattern is formed on each of the two light diffusion sheets in the embodiment.

FIG. 10 is a plan view showing a print pattern formed on each of the two light diffusion sheets in the embodiment.

FIG. 11 shows a relationship between the print pattern on the light diffusion sheet and the arrangement of point light sources in the embodiment.

FIG. 12 is a cross-sectional view showing that a print pattern is formed on both surfaces of a light diffusion sheet in a modification.

FIG. 13A-13D show that a first and second print patterns reduce the luminance unevenness to make the luminance uniform in the embodiment.

FIG. 14 shows results of evaluation of how positional misalignment of the print patterns in Examples and Comparative Example affects the luminance uniformity.

### DETAILED DESCRIPTION

### Embodiment

An optical sheet laminate, a backlight unit, a liquid crystal display device, an information equipment, and a production method for the optical sheet laminate of an embodiment will be described below with reference to the drawings. Note that the scope of the present disclosure is not limited to the following embodiments, and may be altered in any way within the scope of the technical concept of the present disclosure.

### Configuration of Liquid Crystal Display Device

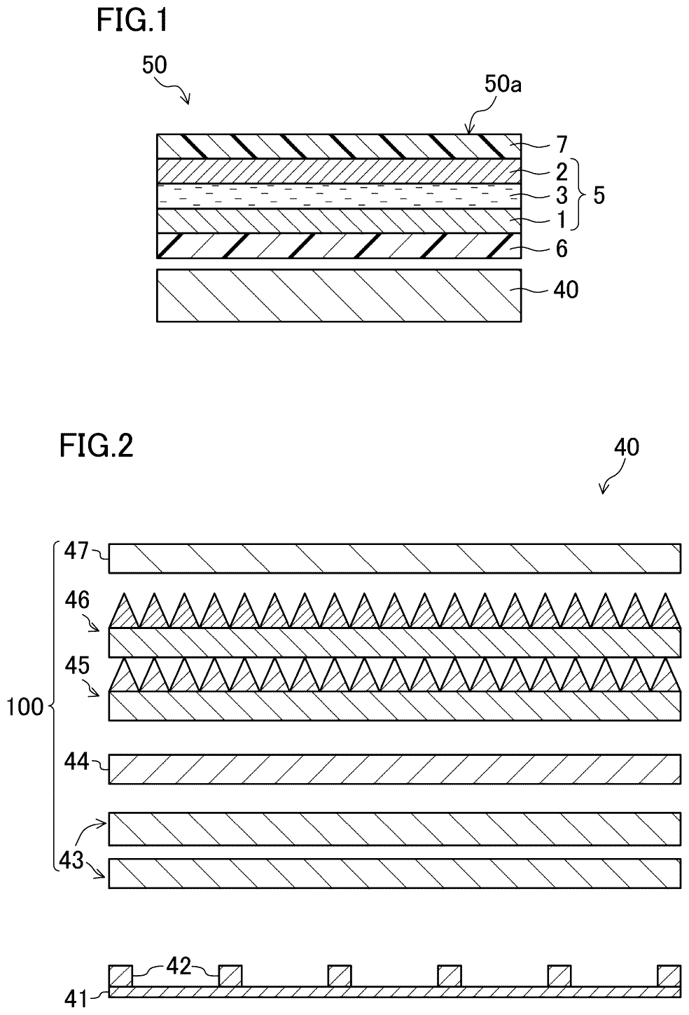

As shown in FIG. 1, a liquid crystal display device 50 includes a liquid crystal display panel 5, a first polarizing plate 6 attached to a lower surface of the liquid crystal display panel 5, a second polarizing plate 7 attached to an upper surface of the liquid crystal display panel 5, and a backlight unit 40 provided on a back surface side of the liquid crystal display panel 5 with the first polarizing plate 6 sandwiched therebetween.

The liquid crystal display panel 5 includes a TFT substrate 1 and a CF substrate 2 provided so as to face each other, a liquid crystal layer 3 provided between the TFT substrate 1 and the CF substrate 2, and a sealing (not shown) provided in a frame shape to seal the liquid crystal layer 3 between the TFT substrate 1 and the CF substrate 2.

The shape of a display screen 50a of the liquid crystal display device 50 viewed from the front (the top in FIG. 1) is basically a rectangle or a square. Alternatively, the shape may be any shape such as a rectangle with rounded corners, an oval, a circle, a trapezoid, or the shape of an instrument panel of an automobile.

The liquid crystal display device 50 applies a voltage of a predetermined magnitude to the liquid crystal layer 3 in sub-pixels corresponding to pixel electrodes, thereby changing the alignment state of the liquid crystal layer 3. This adjusts the transmittance of light incident from the backlight unit 40 through the first polarizing plate 6. The light whose transmittance is adjusted is emitted through the second polarizing plate 7 to display an image on the display screen 50a.

The liquid crystal display device 50 of this embodiment is used as a display apparatus built in various information equipment (e.g., in-vehicle devices such as car navigation systems; personal computers; mobile phones; portable information equipment such as laptops and tablet computers; portable game machines; copying machines; ticket vending machines; automated teller machines; and the like).

The TFT substrate 1 includes, e.g., a plurality of TFTs arranged in a matrix on a glass substrate, an interlayer insulating film arranged in such a manner as to cover the TFTs, a plurality of pixel electrodes arranged in a matrix on the interlayer insulating film and connected to the TFTs, respectively, and an alignment film arranged in such a manner as to cover the pixel electrodes. The CF substrate 2 includes, e.g., a black matrix arranged in a lattice manner on a glass substrate, a color filter including a red layer, a green layer, and a blue layer arranged between lattices of the black matrix, a common electrode arranged in such a manner as to cover the black matrix and the color filter, and an alignment film arranged in such a manner as to cover the common electrode. The liquid crystal layer 3 is made of, e.g., a nematic liquid crystal material containing liquid crystal molecules having electro-optical characteristics. The first polarizing plate 6 and the second polarizing plate 7 each includes, e.g., a polarizer layer having a polarization axis in one direction, and a pair of protective layers arranged in such a manner as to sandwich the polarizer layer.

### Configuration of Backlight Unit

As shown in FIG. 2, the backlight unit 40 includes a reflection member 41, a plurality of point light sources 42 arranged two-dimensionally on the reflection member 41, and an optical sheet laminate 100 provided above the plurality of point light sources 42. The optical sheet laminate 100 includes a light diffusion sheet 43 provided above the plurality of point light sources 42, a color conversion sheet 44 provided above the light diffusion sheet 43, and a pair of prism sheets 45 and 46 provided above the color conversion sheet 44, and another light diffusion sheet 47 provided above the pair of prism sheets 45 and 46.

In this embodiment, the light diffusion sheet 43 includes, e.g., two diffusion sheets layered in the backlight unit 40. The light diffusion sheet 43 may include one diffusion sheet, or three or more diffusion sheets in layers. In particular, the light diffusion sheet 43 may include one diffusion sheet when the luminance uniformity can be sufficiently increased by precise arrangement of the point light sources 42 or the like. When the light diffusion sheet 43 includes a plurality of light diffusion sheets, the specifications (material, thickness, surface shape, and the like) of the light diffusion sheets 43 may be the same or may be different from one another. The pair of prism sheets 45 and 46 may be a first prism sheet 45 and a second prism sheet 46 having prism extending directions (directions in which prism ridges extend) perpendicular to each other.

### [Reflection Member]

The reflection member 41 is formed of, e.g., a white polyethylene terephthalate resin film, a silver-deposited film, or the like.

### [Point Light Sources]

The type of the point light sources 42 is not particularly limited. For example, an LED element, a laser element, or the like may be adopted, and an LED element may be adopted for the sake of costs, productivity, and the like. To adjust a light emission angle characteristics of the LED element, a lens may be attached to the LED element. The LED element (chip) may have a rectangular shape in a plan view, where each side may be 10 μm or more (preferably 50 μm or more) and 20 mm or less (preferably 10 mm or less, more preferably 5 mm or less). The LED chips may be arranged two-dimensionally and alternately at regular intervals on the reflection sheet 41. When the plurality of LED chips are arranged at equal intervals, the distance between the centers of two chips adjacent to each other may be 0.5 mm or more (preferably 2 mm or more) and 20 mm or less. The point light sources 42 such as LED elements arranged regularly exhibit better luminance uniformity.

The point light sources 42 may be arranged on the reflection member 41 formed like a sheet. Alternatively, the point light sources 42 may be embedded in the reflection member 41 so that only the light emitting parts (e.g., lenses attached to the LED elements) of the point light sources 42 are exposed.

The point light sources 42 may be blue light sources. When the blue light sources are used, for example, the color conversion sheet 44 that converts blue light into light of any color (e.g., green or red) is provided between the light diffusion sheet 43 and the first prism sheet 45. The color conversion sheet may be, e.g., a QD (quantum dot) sheet, a fluorescent sheet, or the like. The point light sources 42 may be white light sources. The white light sources may be configured by an LED element having the peak wavelength in a blue region, an LED element having the peak wavelength in a green region, and an LED element having the peak wavelength in a red region. When the point light sources 42 are white light sources, the color conversion sheet 44 may be unnecessary.

### [Light Diffusion Sheet]

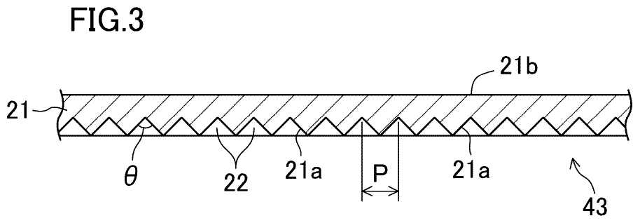

As shown in FIG. 3, the light diffusion sheet 43 includes a base material layer 21. The light diffusion sheet 43 (base material layer 21) includes a light incident surface 21a and a light emission surface 21b. That is, the light diffusion sheet 43 is arranged so that the light incident surface 21a faces the point light sources 42. A resin for a matrix of the base material layer 21 is not particularly limited as long as it is formed of a material that transmits light, and may be, e.g., acrylic, polystyrene, polycarbonate, methyl methacrylate/styrene copolymer (MS) resin, polyethylene terephthalate, polyethylene naphthalate, cellulose acetate, polyimide, or the like. The base material layer 21 may contain a diffusing agent or other additives, or may be substantially free of additives. The additives that the base material layer 21 can contain are not particularly limited. The additives may be inorganic particles such as silica, titanium oxide, aluminum hydroxide, barium sulfate, and the like, and may be as organic particles such as acrylic, acrylonitrile, silicone, polystyrene, polyamide, and the like.

The thickness of the light diffusion sheet 43 is not limited, and may be, e.g., 1.5 mm or less (preferably 1 mm or less) and 0.1 mm or more. If the light diffusion sheet 43 has a thickness of larger than 1.5 mm, it is difficult to reduce the thickness of the liquid crystal display device 50. If the light diffusion sheet 43 has a thickness of less than 0.1 mm, some problems are likely to occur: it is difficult to make the luminance uniform; the light diffusion sheet 43 turns less rigid; and the like. The light diffusion sheet 43 may have a film shape or a plate shape.

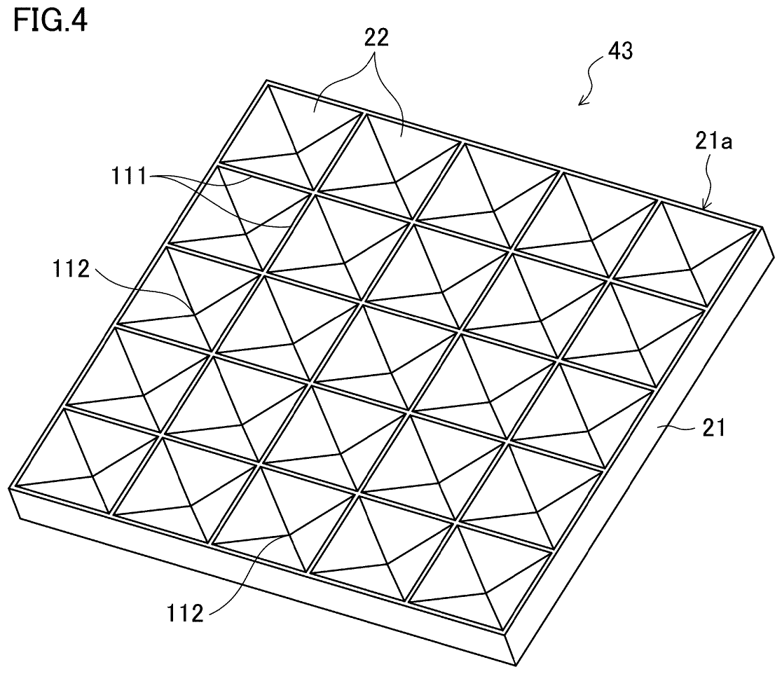

On the light incident surface 21a of the light diffusion sheet 43, a plurality of recesses 22 having, e.g., an inverted quadrangular pyramid shape (inverted pyramid shape) are arranged in a two-dimensional matrix as shown in FIG. 3 and FIG. 4. The plurality of recesses 22 may be arranged along two directions perpendicular to each other. The recesses 22 adjacent to each other are parted by a ridge 111. The ridge 111 extends along the two directions in which the recesses 22 are arrayed. A center 112 (apex of the inverted pyramid) of the recess 22 is a deepest portion of the recess 22. FIG. 4 illustrates that the recesses 22 are arranged in a 5×5 matrix in a light diffusion unit 43A, for simplicity. In a two-dimensional array of the recesses 22, the recesses 22 may be arranged without a space therebetween, or may be arranged with a predetermined space therebetween. Some of the recesses 22 may be randomly arranged to the extent that the light diffusing effect is not lost.

The recess 22 may have an apex angle θ of, e.g., 90°. The recesses 22 may have an arrangement pitch p of, e.g., 100 μm. The recess 22 may have a depth of, e.g., 50 μm. The apex angle θ of the recess 22 is an angle formed by cross-sectional lines of a pair of inclined surfaces of the recess 22 which sandwich the center of the recess 22 and face each other, where the cross-sectional lines appear in a cross section (longitudinal cross section) when the recess 22 is cut by a plane vertical to a surface on which the light diffusion sheet 43 is placed, such that the plane passes through the center of the recess 22 (apex 112 of the inverted pyramid) and vertically traverses the pair of inclined surfaces of the recess 22. The arrangement pitch p of the recesses 22 means a distance between the centers of the recesses 22 (apexes of the inverted pyramids 112) adjacent to each other (i.e., distance in a direction parallel to the arrangement surface of the light diffusion sheet 43).

In the present disclosure, the term “inverted quadrangular pyramid” encompasses not only shapes that can be regarded as a true or approximately inverted quadrangular pyramid, but also “substantially inverted quadrangular pyramid,” in consideration of difficulty in formation of a recess having a geometrically exact inverted quadrangular pyramid shape by an ordinary shape transfer technique. The term “substantial(ly)” XX means that shapes can be approximated to the XX, and the term “substantially inverted quadrangular pyramids” means shapes that can be approximated to the inverted quadrangular pyramids. The “substantially inverted quadrangular pyramid” also includes a deformation of “inverted quadrangular pyramid” with unavoidable shape variations due to the processing accuracy of industrial production. In this embodiment, the recess 22 has an inverted quadrangular pyramid shape, and the same about the inverted quadrangular pyramid shape applies to the recess 22 having another shape such as an inverted polygonal pyramid other than an inverted quadrangular pyramid; an inverted truncated polygon pyramid including an inverted truncated quadrangular pyramid shape; an inverted cone; an inverted truncated cone shape; a lower hemisphere; or the like.

The light emission surface 21b of the light diffusion sheet 43 may be, e.g., a flat surface (mirror surface), a matte surface, or an embossed surface. Alternatively, the light emission surface 21b of the light diffusion sheet 43 may have an uneven surface similar to that on the light incident surface 21a. The light diffusion sheet 43 may have a single layer structure consisting of the base material layer 21 with the light incident surface 21a having an uneven shape (recesses 22). The light diffusion sheet 43 may have a double layer structure consisting of a base material layer having two flat surfaces and a layer having one uneven surface. The light diffusion sheet 43 may have a triple or more layer structure including a layer having one uneven surface. In this embodiment, the light incident surface 21a of the light diffusion sheet 43 has the recesses 22, but instead, the light emission surface 21b may have the recesses 22.

### [Color Conversion Sheet]

The color conversion sheet 44 is a wavelength conversion sheet for converting light (e.g., blue light) emitted from the point light source 42 into light having a wavelength of a certain color (e.g., green or red) as a peak wavelength. The color conversion sheet 44 converts, e.g., blue light with a wavelength of 450 nm into green light with a wavelength of 540 nm and red light with a wavelength of 650 nm. In this case, when the point light source 42 emitting blue light with a wavelength of 450 nm is used, the blue light is partially converted into green light and red light through the color conversion sheet 44, and the light transmitted through the color conversion sheet 44 becomes white light. For example, the color conversion sheet 44 may be, e.g., a QD (quantum dot) sheet, a fluorescent sheet, or the like.

### [Prism Sheet]

The first prism sheet 45 and the second prism sheet 46 refract light rays incident from the color conversion sheet 44 in the normal direction. On the light emission surfaces of the prism sheets 45 and 46, for example, a plurality of grooves each having an isosceles triangular transversal cross-section are provided adjacent to one another, and a triangular prism part sandwiched between a pair of grooves adjacent to each other constitute a prism. The apex angle of the prism is, e.g., about 90°. The grooves formed on the first prism sheet 45 and the grooves formed on the second prism sheet 46 may be arranged so that each groove on the first prism sheet 45 and each groove on the second prism sheet 46 are perpendicular to each other. Accordingly, light rays incident from the color conversion sheet 44 can be refracted in the normal direction by the first prism sheet 45, and light rays emitted from the first prism sheet 45 can be further refracted by the second prism sheet 46 in a direction substantially perpendicular to the light incident surface of the other light diffusion sheet 47. The prism sheets 45 and 46 may be layered as separate sheets, or may be integrated as a single piece. The total thickness of the prism sheets 45 and 46 may be, e.g., about 100 to 400 μm. The prism sheets 45 and 46 may be made of, e.g., polyethylene terephthalate (PET) film with a prism shape formed by using UV-curable acrylic resin.

The lower limit of the thickness of the prism sheets 45 and 46 may be, e.g., about 50 μm, and more preferably about 100 μm. The upper limit of the thickness of the prism sheet 45 and 46 may be, e.g., about 200 μm, and more preferably about 180 μm. The lower limit of the pitch of the prism structure in the prism sheets 45 and 46 may be, e.g., about 20 μm, and more preferably about 25 μm. The upper limit of the pitch of the prism structure in the prism sheets 45 and 46 may be, e.g., about 100 μm, and more preferably about 60 μm.

### [Other Light Diffusion Sheet]

The other light diffusion sheet 47 slightly diffuses light rays incident from the second prism sheet 46, so as to reduce luminance unevenness attributed to the shape of the prism parts of the prism sheets 45 and 46 or the like. The other light diffusion sheet 47 may be directly layered on the surface of the second prism sheet 46. The thickness of the other light diffusion sheet 47 is not limited, and may be, e.g., 50 μm or more and 1.5 mm or less. If the other light diffusion sheet 47 has a thickness of greater than 1.5 mm, it is difficult to reduce the thickness of the liquid crystal display. If the other light diffusion sheet 47 has a thickness of less than 50 μm, some problems are likely to occur: it is difficult to obtain sufficient light diffusing effect; the other light diffusion sheet 47 turns less rigid; and the like. The other light diffusion sheet 47 may have a film shape or a plate shape. The other light diffusion sheet 47 may be made of, e.g., a PET film having surfaces, at least one of which has an uneven shape formed by using a UV-curable acrylic resin.

### [Polarizing Sheet]

Although not shown, a polarizing sheet may be provided above the other light diffusion sheet 47 (i.e., on the side closer to the display screen 50a). The polarizing sheet improves the luminance of the display screen 50a by preventing light emitted from the backlight unit 40 from being absorbed by the first polarizing plate 6 of the liquid crystal display device 50.

### Print Pattern

In the backlight unit 40 shown in FIG. 2, light emitted from the point light sources 42 is diffused by the recesses 22 and a diffusion agent (not shown) when passing through the light diffusion sheet 43. Accordingly, for example, the luminance is reduced in a region directly above the point light sources 42. However, when the distance between the point light sources 42 and the light diffusion sheet 43 is made shorter or the light diffusion sheet 43 is made thinner so that the backlight unit 40 is made thinner, or when a smaller number of the point light sources 42 are provided so that the cost is reduced, luminance unevenness is more likely to be produced between the region directly above the light sources and the region between the light sources (the region where no light sources are arranged).

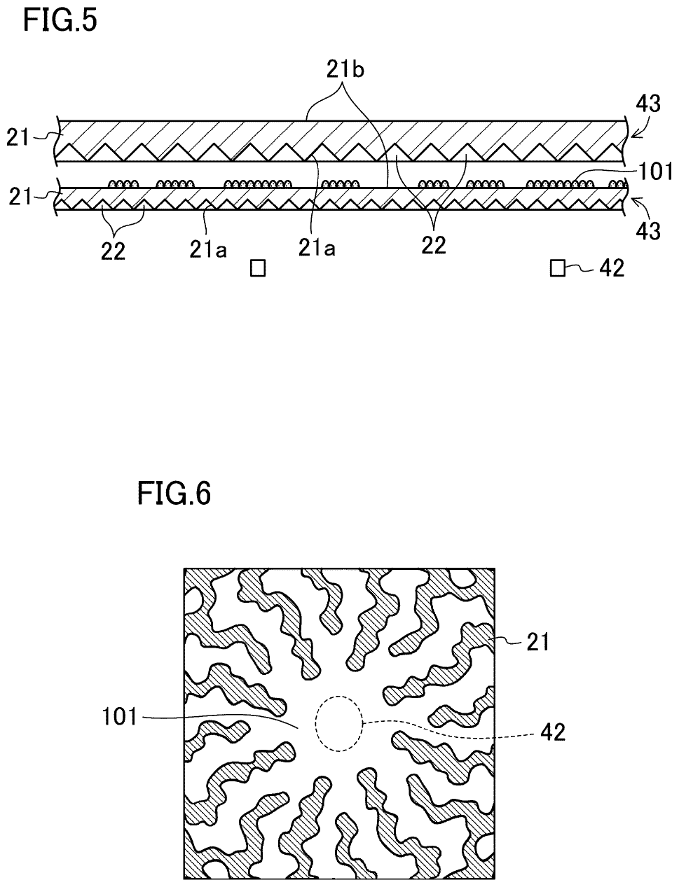

Then, for example, FIG. 5 shows Comparative Example where a print pattern 101 at least partially reducing transmission of light from the plurality of point light sources 42 is formed on the light emission surface 21b of the light diffusion sheet 43 (the lower light diffusion sheet 43), such that the luminance unevenness described above can be reduced. The print pattern 101 is formed of, e.g., a white ink that reflects light. The print pattern 101 is formed, e.g., at a high density in the region directly above the light sources and at a low density in the region between the light sources. Alternatively, the print pattern 101 is formed, e.g., at a high occupancy rate in the region directly above the light sources and at a low occupancy rate in the region between the light sources as shown in FIG. 6. Here, the term “occupancy rate” means a rate of the area that the print pattern (ink-applied portion) occupies in a unit area. In the case of FIG. 6, the occupancy rate in the region directly above the light sources is 100%.

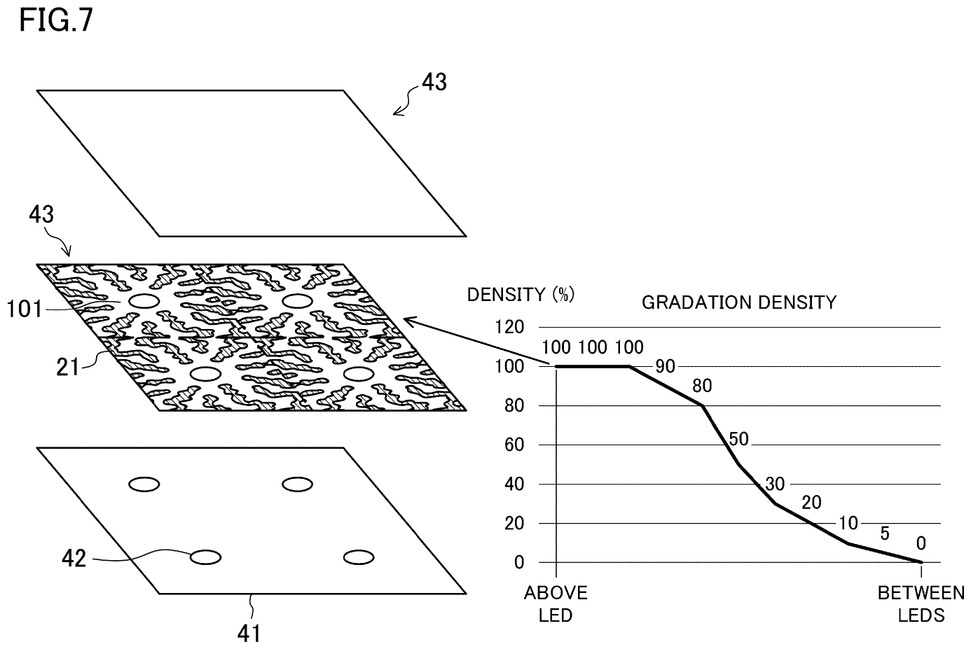

FIG. 7 shows Comparative Example where the print pattern 101 shown in FIG. 6 is provided on the lower light diffusion sheet 43, and shows a relationship between the print pattern 101 and the arrangement of the point light sources 42. The point light sources 42 are LEDs, and are arranged two-dimensionally without uneven distribution. The print pattern 101 is arranged in a gradation manner so that the level of reduction in light transmission decreases outward from a vicinity of a portion directly above the point light source 42. Specifically, the print pattern 101 has a gradation density continuously changing from 100% in a vicinity of a portion directly above the LED to 0% in a region between the LEDs.

However, when a single print pattern 101 is used to reduce the luminance unevenness to improve the luminance uniformity as shown in Comparative Examples in FIG. 5 to FIG. 7, the luminance uniformity significantly decreases when the position of the print pattern 101 is misaligned with respect to the arrangement positions of the point light sources 42.

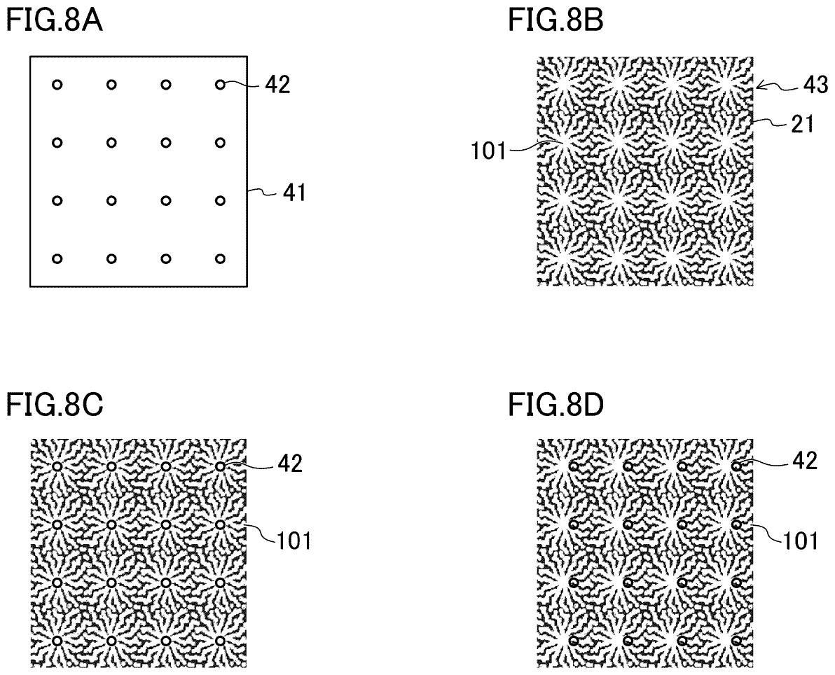

FIG. 8A shows that a plurality of point light sources 42 are arranged two-dimensionally on the reflection sheet 41. FIG. 8B shows that a print pattern 101 is arranged above the light diffusion sheet 43 (base material layer 21), where the print pattern 101 has a pattern that corresponds to luminance distribution (luminance unevenness) attributed to the plurality of point light sources 42. FIG. 8C shows that the arrangement positions of the point light sources 42 match with the formation position of the print pattern 101. FIG. 8D shows that the position of the print pattern 101 is misaligned with respect to the arrangement positions of the point light sources 42.

When the print pattern 101 is arranged so as to correspond to the arrangement of the plurality of point light sources 42 as shown in FIG. 8C, light transmission is reduced in the region directly above the light sources. Thus, the luminance of the region directly above the light sources is lowered, such that the luminance unevenness can be eliminated.

However, when the position of the print pattern 101 is misaligned with respect to the arrangement positions of the point light sources 42 as shown in FIG. 8D, light transmission cannot be sufficiently reduced in the high-luminance region directly above the light sources, and light transmission is excessively reduced in the low-luminance region between the light sources. Consequently, the luminance unevenness is not eliminated and the luminance uniformity is lowered.

To reduce the above-described decrease in the luminance uniformity due to the positional misalignment of the print pattern, the inventors of the present application have arrived at the invention of using a combination of a plurality of print patterns to reduce the luminance unevenness. When a combination of a plurality of print patterns is used to reduce the luminance unevenness, an amount of changes (tone changes) in print density of each of the plurality of print patterns can be smaller than when a single print pattern is used. Thus, even when the plurality of print patterns include a print pattern of which the position is misaligned with respect to the arrangement positions of the light sources, a decrease in the luminance uniformity can be reduced.

The following description provides an example where two print patterns are formed on one of surfaces of each of two light diffusion sheets or on both surfaces of a single light diffusion sheet. Alternatively, the print patterns may be three or more print patterns, and the print patterns may be provided on an optical sheet other than the light diffusion sheet.

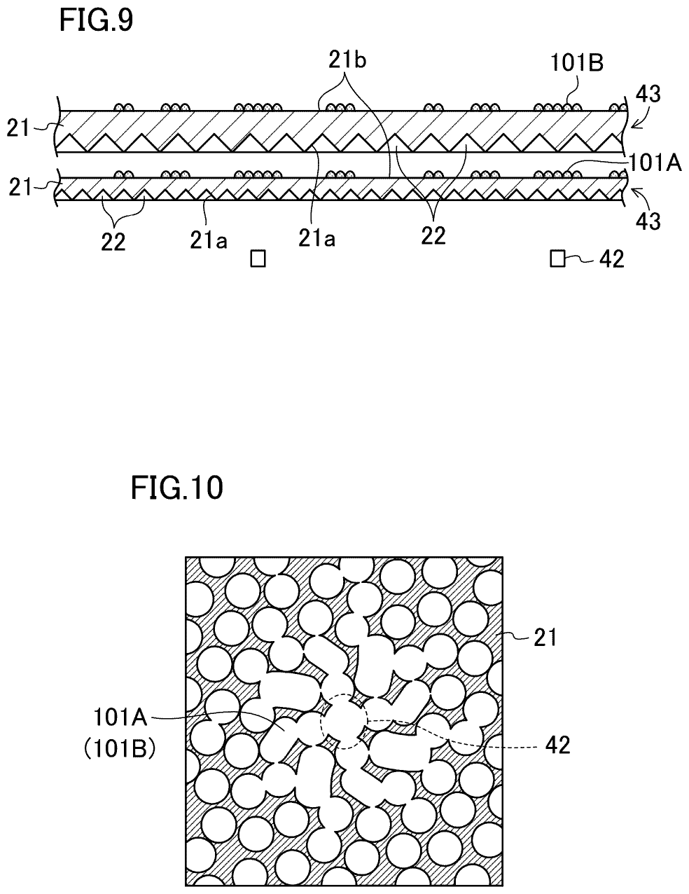

In the configuration of this embodiment shown in FIG. 9, a first print pattern 101A at least partially reducing transmission of light from the plurality of point light sources 42 is formed on the light emission surface 21b of the lower light diffusion sheet 43, and a second print pattern 101B at least partially reducing transmission of light from the plurality of point light sources 42 is formed on the light emission surface 21b of the upper light diffusion sheet 43. In the configuration of this embodiment shown in FIG. 9, the first print pattern 101A and the second print pattern 101B reduce luminance unevenness attributed to the plurality of point light sources 42, thereby making the luminance uniform.

The print patterns 101A and 101B may be formed, e.g., at a high density in the region directly above the light sources and at a low density in the region between the light sources. Alternatively, the print patterns 101A and 101B may be formed, e.g., at a high occupancy rate in the region directly above the light sources and at a low occupancy rate in the region between the light sources as shown in FIG. 10. A print unit of the print patterns 101A and 101B may be, e.g., a dot shape such as a circular shape, or may be a line shape. The print patterns 101A and 101B may be a solid shape in the region directly above the light sources.

In the present disclosure, a shape recognized as a granular shape such as a circle, a triangle, a quadrangle, and the like is referred to as a “dot shape;” a shape recognized as a straight line or a wavy line is referred to as a “line shape;” and a shape excluding the “dot shape” and the “line shape” and having a plane (two-dimensional surface) is referred to as a “solid shape (derived from “solid” of solid printing).”

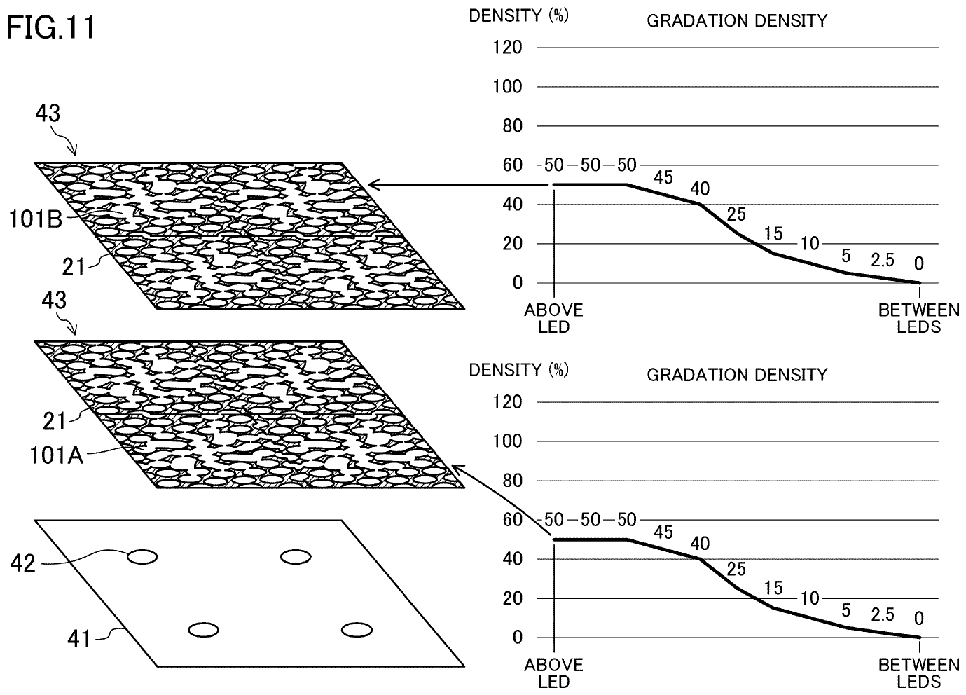

FIG. 11 shows the configuration of this embodiment where the print patterns 101A and 101B shown in FIG. 10 are provided on the lower and upper light diffusion sheets 43, and shows a relationship between the print patterns 101A and 101B and the arrangement of the point light sources 42. The point light sources 42 are LEDs, and are arranged two-dimensionally without uneven distribution. The print patterns 101A and 101B are each a collection of unit patterns arranged in a gradation manner so that the level of reduction in light transmission decreases from a vicinity of a portion directly above one single point light source 42 toward an intermediate region between the one single point light source 42 and another point light source 42 adjacent to the one single point light source 42. Those unit patterns are arranged two-dimensionally without uneven distribution to serve as the print patterns 101A and 101B. Specifically, while the print pattern 101 in Comparative Example shown in FIG. 7 has a gradation density of 100% in a portion directly above the LED, the print patterns 101A and 101B have a gradation density continuously changing from 50% in a vicinity of a portion directly above an LED to 0% in a region between LEDs. Further, the print pattern 101A, the print pattern 101B, and a pattern formed by stacking the print pattern 101A and the print pattern 101B are each a pattern having a print density corresponding to the luminance in a luminance distribution produced by the point light sources 42 when the print patterns 101A and 101B are not provided. The luminance and the print density have a positive correlation with each other.

Only one of the print pattern 101A or the print pattern 101B may be the above-described pattern having a print density corresponding to the luminance in a luminance distribution, and the luminance and the print density may have a positive correlation with each other.

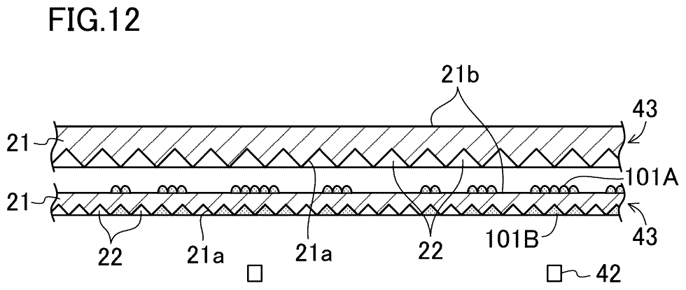

Instead of the configuration of this embodiment shown in FIG. 9 to FIG. 11, the first print pattern 101A may be formed on the light emission surface 21b of the lower light diffusion sheet 43, and the second print pattern 101B may be formed on the light incident surface 21a of the same lower light diffusion sheet 43, like the configuration of the modification shown in FIG. 12. Here, the second print pattern 101B is arranged so that a plurality of recesses 22 provided on the light incident surface 21a of the light diffusion sheet 43 are filled with the second print pattern 101B. Also in the configuration of the modification shown in FIG. 12, the first print pattern 101A and the second print pattern 101B reduce luminance unevenness attributed to the plurality of point light sources 42, thereby making the luminance uniform. In the configuration of the modification shown in FIG. 12, the print patterns 101A and 101B are formed on both surfaces of the lower light diffusion sheet 43, but instead, the print patterns 101A and 101B may be formed on both surfaces of the upper light diffusion sheet 43.

In this embodiment (including the modifications; the same applies hereinafter), the material for the print patterns 101A and 101B is not particularly limited as long as the material can be used for printing and reduce light transmission. The material may be an ink material, specifically a white ink with a high reflectance, that reflects, absorbs, or diffuses light. The white ink may be formed of a medium (resin serving as a base), a white pigment, a white dye, a curing component, and the like. The type of ink may be a heat-curable ink such as a heat-reactive ink, a solvent-evaporable ink, and the like, that is cured by using a heat source; a UV-curable ink that is cured by using ultraviolet rays; or a mixture of the two. The white pigment may be, e.g., titanium oxide. The solvent may be, e.g., an organic solvent such as toluene or the like. An adhesive resin may be, e.g., an acrylic resin.

In this embodiment, the print patterns 101A and 101B may be a collection of unit patterns arranged in a gradation manner so that the level of reduction in light transmission decreases from a vicinity of a portion directly above one single point light source 42 out of a plurality of point light sources 42 toward an intermediate region between the one single point light source 42 and another point light source 42 adjacent to the one single point light source 42. Those unit patterns may be arranged two-dimensionally without uneven distribution to serve as the print patterns 101A and 101B. Alternatively, at least one of the print patterns 101A or 101B may be a pattern having a print density corresponding to the luminance in a luminance distribution (hereinafter simply referred to as “luminance distribution”) produced by the plurality of point light sources 42 when the print patterns 101A and 101B are not provided, and the luminance and the print density may have a positive correlation with each other. In other words, the print patterns 101A and 101B may be provided with a relatively high density or a relatively high occupancy rate in a high luminance region of the luminance distribution. The high luminance region may be, e.g., a region directly above the point light source 42. Alternatively, a pattern formed by stacking the print pattern 101A and the print pattern 101B may be a pattern having a print density corresponding to the luminance in a luminance distribution produced by the plurality of point light sources 42 when the print patterns 101A and 101B are not provided, and the luminance and the print density may have a positive correlation with each other.

When the print patterns 101A and 101B are formed by dot printing using a white ink, the total light transmittance, i.e., the luminance decreases as the area ratio of dot printing increases. Thus, by adjustment to the area ratio of dot printing, the total light transmittance corresponding to a luminance reduction level required in the high luminance region can be easily achieved. In other words, the luminance uniformity can be improved by studying in advance the position of the high luminance region and the luminance reduction level required in the high luminance region; and then forming the print patterns 101A and 101B in the high luminance region of the light diffusion sheet 43 by dot printing using a white ink with the area ratio corresponding to the required luminance reduction level.

The above embodiment provides an example where the high luminance region in the luminance distribution is a region directly above the light sources. However, the high luminance region may be a region between the light sources, which is a region between adjacent point light sources 42, instead of the region directly above the light sources, depending on the configuration of the backlight unit 40 (optical sheet laminate 100), the configuration of the light diffusion sheet 43, the characteristics of the reflection member 41 and the point light sources 42, and the like. In this case, the print patterns 101A and 101B provided in the region between the light sources that is a high luminance region can reduce luminance unevenness. Note that the region between the light sources includes not only a region between point light sources 42 adjacent to each other in two directions in which the point light sources 42 are arranged, but also a region between point light sources 42 adjacent to each other in a direction (diagonal direction) inclined with respect to the directions in which the point light sources 42 are arranged.

In this embodiment, the print patterns 101A and 101B may be arranged in a gradation manner so that as the luminance in the luminance distribution becomes higher, the arrangement density becomes higher. Arranging the print pattern in a gradation manner means changing the arrangement density of the print pattern. The arrangement density of the print pattern refers to a ratio of an area occupied by the print pattern in a unit area. For example, for a dot shape gradation, the area ratio is calculated based on “an area of a single dot in a unit area” multiplied by “the number of dots in a unit area” (a plurality of dot sizes are taken into account, if any). For example, for a line shape gradation, the area ratio is calculated based on “an area of a single line in a unit area” multiplied by “the number of lines in a unit area” (a plurality of line sizes are taken into account, if any). For example, for a solid shape gradation, the area ratio is calculated based on “an area of a single solid shape in a unit area” multiplied by “the number of solid shapes in a unit area” (a plurality of solid sizes are taken into account, if any). The arrangement density of the print pattern arranged in a gradation manner changes between 100% (complete solid) and 0%. The range of the arrangement density between 100% and 0% includes 100% and 0%, but the maximum value and the minimum value of the arrangement density of the luminance print pattern do not always have to be 100% and 0%, respectively. The arrangement density may change linearly or may change curvilinearly. The arrangement density may change monotonously like a monotonic increase or a monotonic decrease (e.g., 100% to 0%), or may change up and down (e.g., 100% to 50% to 70% to 0%). The “unit area” representing the arrangement density of the print pattern may be set to any unit area.

The print patterns 101A and 101B may be provided in a dot shape or its reversed shape. The shape of a dot is not limited to a circle, and may be a triangle, a quadrangle, a hexagon, or other shapes. Alternatively, dots may have a plurality of different shapes. Alternatively, a plurality of dots having different sizes may be used. A dot size, a dot interval, and the like are set to any size, interval, and the like by, e.g., adjustment to the arrangement density of the white ink according to the luminance distribution. The print patterns 101A and 101B may include combination of dot portions or its reversed portions and line portions or solid portions.

The print patterns 101A and 101B may be provided in a line shape such as a straight line shape, a wavy line shape, or the like, or in a reversed shape thereof. The shape of the lines are not particularly limited, and the lines may have a plurality of different shapes. Alternatively, a plurality of lines having different dimensions may be used. A line width, a line length, a line interval, and the like are set to any width, length, interval, and the like by, e.g., adjustment to the arrangement density of the white ink according to the luminance distribution. The print patterns 101A and 101B may include combination of line portions or its reversed portions and dot portions or solid portions.

### Production Method for Optical Sheet Laminate

A production method of this embodiment for an optical sheet laminate 100 includes a step A of forming a first print pattern 101A at least partially reducing transmission of light from a plurality of point light sources 42, on a first surface (e.g., light emitting surface 21b) of a first optical sheet (e.g., lower light diffusion sheet 43); and a step B of forming a second print pattern 101B at least partially reducing transmission of light from a plurality of point light sources 42, on a second optical sheet (e.g., upper light diffusion sheet 43) different from the first optical sheet, or on a second surface (e.g., light incident surface 21a) of the first optical sheet. The step A and the step B are performed so that the print patterns 101A and 101B reduce luminance unevenness attributed to the plurality of point light sources 42, thereby making the luminance uniform.

In the production method of this embodiment for the optical sheet laminate 100, the print patterns 101A and 101B may be a collection of unit patterns arranged in a gradation manner so that the level of reduction in light transmission decreases from a vicinity of a portion directly above one single point light source 42 out of a plurality of point light sources 42 toward an intermediate region between the one single point light source 42 and another point light source 42 adjacent to the one single point light source 42. Those unit patterns may be arranged two-dimensionally without uneven distribution to serve as the print patterns 101A and 101B.

Alternatively, at least one of the print patterns 101A or 101B may be a pattern having a print density corresponding to the luminance in a luminance distribution produced by the plurality of point light sources 42 when the print patterns 101A and 101B are not provided, and the luminance and the print density may have a positive correlation with each other. Alternatively, a pattern formed by stacking the print pattern 101A and the print pattern 101B may be a pattern having a print density corresponding to the luminance in a luminance distribution produced by the plurality of point light sources 42 when the print patterns 101A and 101B are not provided, and the luminance and the print density may have a positive correlation with each other. In this case, the high luminance region in the luminance distribution may be a region directly above the plurality of point light sources 42 or a region between the point light sources 42 adjacent to each other out of the plurality of point light sources 42, depending on the configuration of the optical sheet laminate 100, the characteristics of the point light sources 42, and the like.

A method of printing the print patterns 101A and 101B is not particularly limited, and for example, screen printing, offset printing, inkjet printing, and the like may be adopted. A printing ink for forming the print patterns 101A and 101B is not particularly limited as long as the ink is usable for printing, and for example, an ultraviolet-curable ink, a heat-curable ink, an evaporation-drying ink, an oxidation polymerization ink, or the like may be used. In terms of reduction in light transmission, the printing ink is preferably a white ink, a gray ink, or the like.

The method of forming a shape such as a recess 22 and the like in the light diffusion sheet 43 is not particularly limited, and for example, extrusion molding, injection molding, laser processing, mold transfer, or the like may be employed.

A single layer light diffusion sheet having an uneven surface may be manufactured by extrusion molding as follows. First, a plastic resin as pellets (a diffusion agent may be added) is introduced into a single-screw extruder. Then, the plastic particles are heated, molten, and kneaded. After that, a molten resin extruded from a T-die is sandwiched and cooled between two metal rolls, then transported by guide rolls, and cut off into sheet plates by a sheet cutter machine to produce light diffusion sheets. Here, a molten resin is sandwiched between metal rolls, one of which has a surface with an inverted shape of a desired unevenness, which will be transferred onto the resin. This allows for shaping of light diffusion sheets having surfaces with the desired unevenness. The surface shapes of the rolls are not perfectly transferred onto the resin, and thus may be designed in consideration of how completely the shapes are transferred. Instead of cutting an extrusion-molded resin into sheet plates by the sheet cutter machine, the resin may be once wound into a roll shape and then cut into sheet plates in a subsequent step (a punching step after printing).

If a two-layered light diffusion sheet with uneven surfaces is manufactured by extrusion molding, for example, plastic particles as pellets necessary for forming each layer may be introduced into each of two single-screw extruders. Then, the same procedure may be performed for each layer, and the fabricated sheets may be layered.

Alternatively, the two-layered light diffusion sheet with an uneven surface may be manufactured as follows. First, plastic particles as pellets necessary for forming each layer are introduced into each of two single-screw extruders, and molten by heating, and kneaded. Then, two molten resins formed into each layer are introduced into a single T-die so that molten resins are layered in the T-die. Then, the layered molten resins extruded from the T-die are sandwiched and cooled between two metal rolls After that, the layered molten resins are transported by guide rolls, and cut off into sheet plates using a sheet cutter machine, thus yielding a two-layered light diffusion sheet with an uneven surface. Instead of cutting a layered resin into sheet plates by the sheet cutter machine, the resin may be once wound into a roll shape and then cut into sheet plates in a subsequent step (a punching step after printing).

The diffusion sheet may be manufactured by shape-transfer using ultraviolet (UV) as follows. First, an uncured ultraviolet curable resin is filled in a roll surface having an inverted shape of an uneven shape to be transferred, and a base material is pressed onto the resin. Next, with the roll filled with ultraviolet curable resin and the base material in one piece, the resin is cured by UV irradiation. Next, the sheet to which the uneven shape has been transferred by using the resin is released from the roll. Finally, the sheet is irradiated with ultraviolet rays again to completely cure the resin, thereby producing a light diffusion sheet having an uneven surface.

### Features of Embodiment

The optical sheet laminate 100 of this embodiment is built in the liquid crystal display device 50 including the display screen 50a, on a back surface side of which the plurality of point light sources 42 are provided in a dispersed manner. The optical sheet laminate 100 includes the first optical sheet (lower light diffusion sheet 43) having the first surface (light emission surface 21b) on which the first print pattern 101A at least partially reducing transmission of light from the plurality of point light sources 42 is formed. The second print pattern 101B at least partially reducing transmission of light from the plurality of point light sources 42 is formed on the second optical sheet (upper light diffusion sheet 43) different from the first optical sheet, or on the second surface (light incident surface 21a) of the first optical sheet. The first print pattern 101A and the second print pattern 101B reduce luminance unevenness attributed to the plurality of point light sources 42, thereby making the luminance uniform.

In the optical sheet laminate 100 of this embodiment, the first and second print patterns 101A and 101B that reduce luminance unevenness are arranged on a plurality of different optical sheets (the lower light diffusion sheet 43 and the upper light diffusion sheet 43), respectively, or on both surfaces of a single optical sheet (lower light diffusion sheet 43). Thus, an amount of changes (tone changes) in the print density (arrangement density) in the first and second print patterns 101A and 101B can be smaller than when a single print pattern is used to reduce luminance unevenness. Thus, the luminance uniformity can be less reduced even when the position of the first print pattern 101A and/or the second print pattern 101B is/are misaligned with respect to the arrangement positions of the light sources.

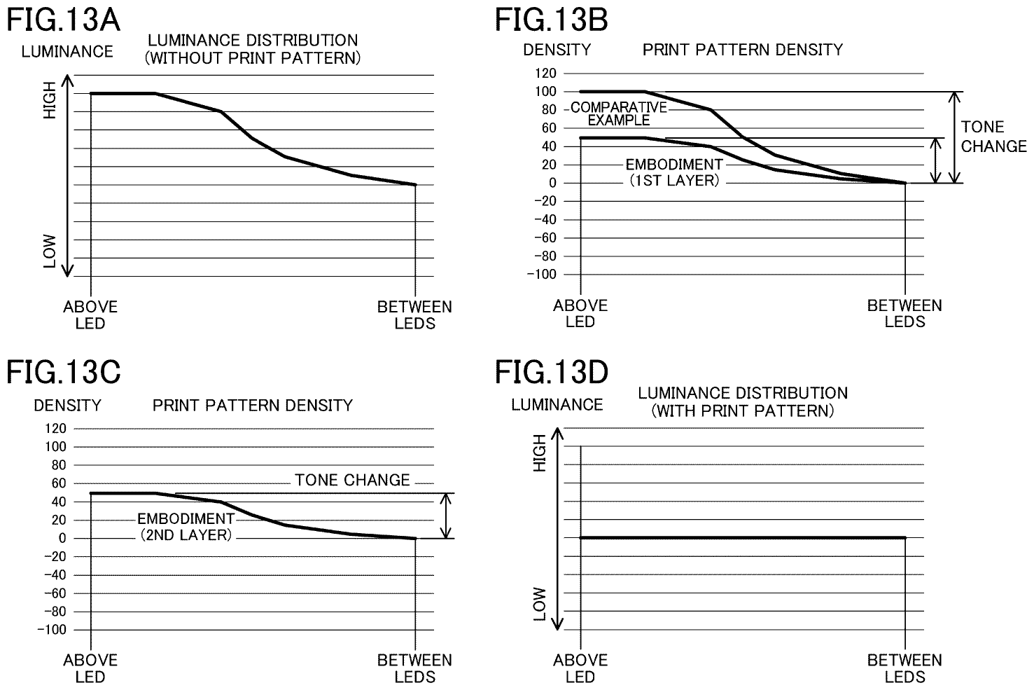

FIG. 13A shows an exemplary luminance distribution where the optical sheet laminate 100 is not provided with a print pattern. The point light sources 42 are LEDs. As shown in FIG. 13A, the luminance is relatively high in a region above the LED, and the luminance is relatively low in a region between LEDs. That is, there is luminance unevenness.

FIGS. 13B and 13C show exemplary arrangement density in a print pattern for eliminating the luminance unevenness shown in FIG. 13A. The arrangement density is presented as a relative density, where the arrangement density of a region immediately above the LED in a single print pattern 101 of Comparative Example is 100.

FIG. 13D shows that the print pattern is provided on the optical sheet laminate 100 without positional misalignment so that the luminance unevenness is eliminated.

In the single print pattern 101 of Comparative Example, as shown in FIG. 13B, there is a significant tone change from the density of 100 in the region directly above the LED to the density of 0 in the region between LEDs. Thus, when the position of the print pattern 101 is misaligned with respect to the arrangement positions of the LEDs, the level of reduction in the luminance uniformity is larger.

On the other hand, as shown in FIGS. 13B and 13C, in the first print pattern 101A (first layer) and the second print pattern 101B (second layer) of this embodiment, there is a half tone change as compared to Comparative Example, from the density of 50 in the region directly above the LED to the density of 0 in the region between LEDs. Thus, even when the position of the first print pattern 101A and/or the second print pattern 101B is/are misaligned with respect to the arrangement positions of the LEDs, the level of reduction in the luminance uniformity can be smaller.

In the example shown in FIG. 13A-13D, each of the first and second print patterns 101A and 101B reduces a half of a luminance difference between the region above the LED and the region between LEDs (hereinafter simply referred to as “luminance difference”). However, in the range where combination of the first and second print patterns 101A and 101B substantially eliminate luminance unevenness, each of the first and second print patterns 101A and 101B may reduce about 20% to 80%, preferably about 30% to 70%, more preferably about 40% to 60% of the luminance difference.

In the optical sheet laminate 100 of this embodiment, the print patterns 101A and 101B may be a collection of unit patterns arranged in a gradation manner so that the level of reduction in light transmission decreases from a vicinity of a portion directly above one single point light source 42 out of a plurality of point light sources 42 toward an intermediate region between the one single point light source 42 and another point light source 42 adjacent to the one single point light source 42. Those unit patterns may be arranged two-dimensionally without uneven distribution to serve as the print patterns 101A and 101B. Alternatively, at least one of the first and second print patterns 101A and 101B may be a pattern having a print density corresponding to the luminance in a luminance distribution produced by the plurality of point light sources 42 when the first and second print patterns 101A and 101B are not provided, and the luminance and the print density may have a positive correlation with each other. Alternatively, a pattern formed by stacking the first print pattern 101A and the second print pattern 101B may be a pattern having a print density corresponding to the luminance in a luminance distribution produced by the plurality of point light sources 42 when the first and second print patterns 101A and 101B are not provided, and the luminance and the print density may have a positive correlation with each other. In this way, the first and second print patterns 101A and 101B reduce luminance unevenness attributed to the plurality of point light sources 42, thereby improving the luminance uniformity. In this case, the high luminance region in the luminance distribution may be a region directly above the plurality of point light sources 42 or a region between the point light sources 42 adjacent to each other out of the plurality of point light sources 42, depending on the configuration of the optical sheet laminate 100, the characteristics of the point light sources 42, and the like. In this way, the luminance is reduced in a region directly above the point light source 42 or in a region between the point light sources 42, and the luminance uniformity can be improved.

In the optical sheet laminate 100 of this embodiment, the optical sheet provided with the first print pattern 101A may be the light diffusion sheet 43 (lower light diffusion sheet 43). In this way, the light diffusion sheet 43 can further reduce luminance unevenness. In this case, when the second print pattern 101B is formed on the other optical sheet (upper light diffusion sheet 43); in the lower light diffusion sheet 43, the first surface (light emission surface 21b) provided with the first print pattern 101A is a flat surface or a matte surface, and the second surface (light incident surface 21a) is provided with the plurality of recesses 22 arranged two-dimensionally; and in the upper light diffusion sheet 43, the second print pattern 101B is formed on the light emission surface 21b as a flat surface or a matte surface, it is easy to form the first and second print patterns 101A and 101B on a flat surface or a matte surface having small unevenness. Alternatively, when the second print pattern 101B is also formed on the lower light diffusion sheet 43; one surface (light incident surface 21a) out of the first surface and the second surface of the lower light diffusion sheet 43 is provided with a plurality of recesses 22 arranged two-dimensionally; and the other surface (light emission surface 21b) out of the first surface or the second surface is a flat surface or a matte surface, one print pattern (second print pattern 101B) out of the first print pattern 101A and the second print pattern 101B is stuffed into the recesses 22 to get thick, and thus the light transmission can be more reduced. The plurality of recesses 22 may have an inverted polygon pyramid shape, an inverted truncated polygon pyramid shape, or a lower hemisphere shape. In this way, the light diffusion property of the light diffusion sheet 43 can be improved.

The backlight unit 40 of this embodiment is built in the liquid crystal display device 50, leads light emitted from the plurality of point light sources 42 toward the display screen 50a, and includes the optical sheet laminate 100 of this embodiment between the display screen 50a and the plurality of point light sources 42. In this way, the luminance uniformity can be improved.

In the backlight unit 40 of this embodiment, the distance between the plurality of point light sources 42 and the optical sheet laminate 100 may be 2 mm or less. In this way, the luminance uniformity can be improved even in a configuration where the luminance distribution is likely to have unevenness in a conventional light diffusion sheet. That is, the backlight unit 40 of this embodiment is a direct type backlight unit including the liquid crystal display device 50 including the display screen 50a, on a back surface side of which the plurality of point light sources 42 are provided in a dispersed manner. Thus, it is necessary to shorten the distance between the point light sources 42 and the optical sheet laminate 100 to make the liquid crystal display device 50 thinner and smaller. However, if the distance is shortened, for example, the phenomenon (luminance unevenness) where the luminance of the display screen 50a in a portion positioned on a region between the point light sources 42 provided in a dispersed manner is lower than that in the other portions is likely to appear. In response, the optical sheet laminate 100 of this embodiment provided with the first and second print patterns 101A and 101B is useful for reduction in the luminance unevenness. In particular, the optical sheet laminate 100 of this embodiment is believed to be more significantly useful, when the distance between the point light sources and the optical sheet laminate is 10 mm or less, preferably 5 mm or less, more preferably 2 mm or less, and ultimately 0 mm, aiming to reduce the thickness of a small and mid-sized liquid crystal display device in the future.

In the backlight unit 40 of this embodiment, the point light sources 42 may be LED elements. In this way, even when the number of light sources is reduced, the luminance on the entire display screen can be obtained sufficiently.

In the backlight unit 40 of this embodiment, the point light sources 42 may be arranged on the reflection member 41 provided on an opposite side of the display screen 50a as seen from the optical sheet laminate 100. In this way, the luminance uniformity can be more improved.

The liquid crystal display device 50 of this embodiment includes the backlight unit 40 of this embodiment and the liquid crystal display panel 5. Thus, the luminance uniformity is improved. An information equipment provided with the liquid crystal display device 50 of this embodiment can obtain the same advantage.

The production method of this embodiment for the optical sheet laminate 100 is a production method for the optical sheet laminate 100 built in the liquid crystal display device 50 including the display screen 50a, on a back surface side of which the plurality of point light sources 42 are provided in a dispersed manner. The production method of this embodiment for the optical sheet laminate 100 includes a step A of forming a first print pattern 101A at least partially reducing transmission of light from a plurality of point light sources 42, on a first surface (light emitting surface 21b) of a first optical sheet (lower light diffusion sheet 43); and a step B of forming a second print pattern 101B at least partially reducing transmission of light from a plurality of point light sources 42, on a second optical sheet (upper light diffusion sheet 43) different from the first optical sheet, or on a second surface (light incident surface 21a) of the first optical sheet. The step A and the step B are performed so that the first and second print patterns 101A and 101B reduce luminance unevenness attributed to the plurality of point light sources 42, thereby making the luminance uniform.

According to the production method of this embodiment for the optical sheet laminate 100, the first and second print patterns 101A and 101B that reduce luminance unevenness are formed on a plurality of different optical sheets (the lower light diffusion sheet 43 and the upper light diffusion sheet 43), respectively, or on both surfaces of a single optical sheet (lower light diffusion sheet 43). Thus, tone changes in the first and second print patterns 101A and 101B can be smaller than when a single print pattern is used to reduce luminance unevenness. Thus, the luminance uniformity can be less reduced even when the position of the first print pattern 101A and/or the second print pattern 101B is/are misaligned with respect to the arrangement positions of the point light sources 42.

In the production method of this embodiment for the optical sheet laminate 100, the print patterns 101A and 101B may be a collection of unit patterns arranged in a gradation manner so that the level of reduction in light transmission decreases from a vicinity of a portion directly above one single point light source 42 out of a plurality of point light sources 42 toward an intermediate region between the one single point light source 42 and another point light source 42 adjacent to the one single point light source 42. Those unit patterns may be arranged two-dimensionally without uneven distribution to serve as the print patterns 101A and 101B. Alternatively, at least one of the first and second print patterns 101A and 101B may be a pattern having a print density corresponding to the luminance in a luminance distribution produced by the plurality of point light sources 42 when the first and second print patterns 101A and 101B are not provided, and the luminance and the print density may have a positive correlation with each other. Alternatively, a pattern formed by stacking the first print pattern 101A and the second print pattern 101B may be a pattern having a print density corresponding to the luminance in a luminance distribution produced by the plurality of point light sources 42 when the first and second print patterns 101A and 101B are not provided, and the luminance and the print density may have a positive correlation with each other. In this way, the first and second print patterns 101A and 101B reduce luminance unevenness attributed to the plurality of point light sources 42, thereby improving the luminance uniformity. In this case, the high luminance region in the luminance distribution may be a region directly above the plurality of point light sources 42 or a region between the point light sources 42 adjacent to each other out of the plurality of point light sources 42, depending on the configuration of the optical sheet laminate 100, the characteristics of the point light sources 42, and the like. In this way, the luminance is reduced in a region directly above the point light source 42 or in a region between the point light sources 42, and the luminance uniformity can be improved.

### Example

The following describes results of evaluation of how positional misalignment of the print patterns in Example and Comparative Examples affects the luminance uniformity.

The configuration of the backlight unit 40 shown in FIG. 2 was used for an evaluation sample of Example. Specifically, a blue LED array with blue mini LEDs arranged at a pitch of 2.5 mm was used for the plurality of point light sources 42. The light diffusion sheet 43 included two light diffusion sheets 43 in layer. The lower light diffusion sheet 43 had a thickness of 130 μm, and the upper light diffusion sheet 43 had a thickness of 190 μm. Each of the light diffusion sheets 43 included the light incident surface 21a provided with a plurality of recesses 22 having an inverted pyramid shape and arranged two-dimensionally, and each of the light diffusion sheets 43 included the light emission surface 21b as a matte surface. Each of the light diffusion sheets 43 was formed by processing polycarbonate serving as the base material layer 21 by extrusion molding and arranging the recesses 22 two-dimensionally thereon. No diffusing agent was added to each of the light diffusion sheets 43. On the lower light diffusion sheet 43, the recesses 22 having an inverted pyramid shape with a depth of 50 μm were arranged at a pitch of 100 μm. On the upper light diffusion sheet 43, the recesses 22 having an inverted pyramid shape with a depth of 100 μm were arranged at a pitch of 180 μm. The first and second print patterns 101A and 101B were formed on two light diffusion sheets 43, respectively, as shown in FIG. 9 and FIG. 11. As Comparative Example, as shown in FIG. 5 and FIG. 7, an evaluation sample including a single print pattern 101 formed on only the lower light diffusion sheet 43 was also prepared. As Comparative Examples, two different print patterns 101 of Comparative Example 1 and Comparative Example 2 were prepared. The first and second print patterns 101A and 101B of Example and the print pattern 101 of Comparative Examples were all formed by gradation printing using a white ink. For the white ink, a two-component reactive curable ink (heat curable ink) was used of which the reflectance to light having a wavelength of 460 nm is about 88% when the printing thickness is about 18 μm. For the gradation printing, screen printing was used, where the printing thickness was set to about 18 μm. The arrangement densities (print densities) of the first and second print patterns 101A and 101B of Example were set to half of the arrangement densities (print densities) of the print patterns 101 of Comparative Examples. To reduce floating of the sheets constituting the backlight unit 40, a transparent glass plate was placed on the other light diffusion sheet 47.

To evaluate how positional misalignment of the print patterns with respect to the arrangement positions of the light sources affects the luminance uniformity, in a “pattern positional misalignment 1,” the first pattern 101A and the second print pattern 101B were misaligned from a predetermined position (position without positional misalignment; the same applies hereinafter) by 300 μm and 500 μm in an oblique direction of 45 degrees (hereinafter referred to as a θ direction in some cases) with respect to the two-dimensional arrangement direction of the point light sources 42. In a “pattern positional misalignment 2,” only the first pattern 101A was misaligned from the predetermined position by 300 μm and 500 μm in a θ direction, whereas the second print pattern 101B is formed in the predetermined position without positional misalignment. In a “pattern positional misalignment 3,” the first pattern 101A was misaligned from the predetermined position by 300 μm and 500 μm in a θ direction, whereas the second print pattern 101B was misaligned from the predetermined position by 300 μm and 500 μm in a direction opposite by 180 degrees from the θ direction. For Comparative Examples, the print pattern 101 was misaligned from the predetermined position by 300 μm and 500 μm in the θ direction.

For the evaluation samples of Example and Comparative Examples configured as described above, the luminance in the upward vertical direction (a direction from the LED array toward the glass plate) was measured using a two-dimensional color luminance meter UA-200 manufactured by TOPCON TECHNOHOUSE CORPORATION. Next, for two-dimensional luminance distribution images obtained, variation in the light emitting intensity of individual LEDs was corrected and filtering process was conducted to reduce noises of bright/dark spots attributed to foreign materials and the like. Then, average and standard deviation were calculated for the luminance of all the pixels. Finally, the luminance uniformity was calculated for the evaluation samples of Example and Comparative Examples, where the “luminance uniformity” is defined as “average value of luminance/standard deviation of luminance.” For calculation of the luminance uniformity, the luminance measurement results were mapped two-dimensionally, and a region of 16 LEDs (four LEDs in longitudinal direction×four LEDs in lateral direction) without deficiencies or unevenness was extracted. Then, every calculation was conducted in the extracted region.

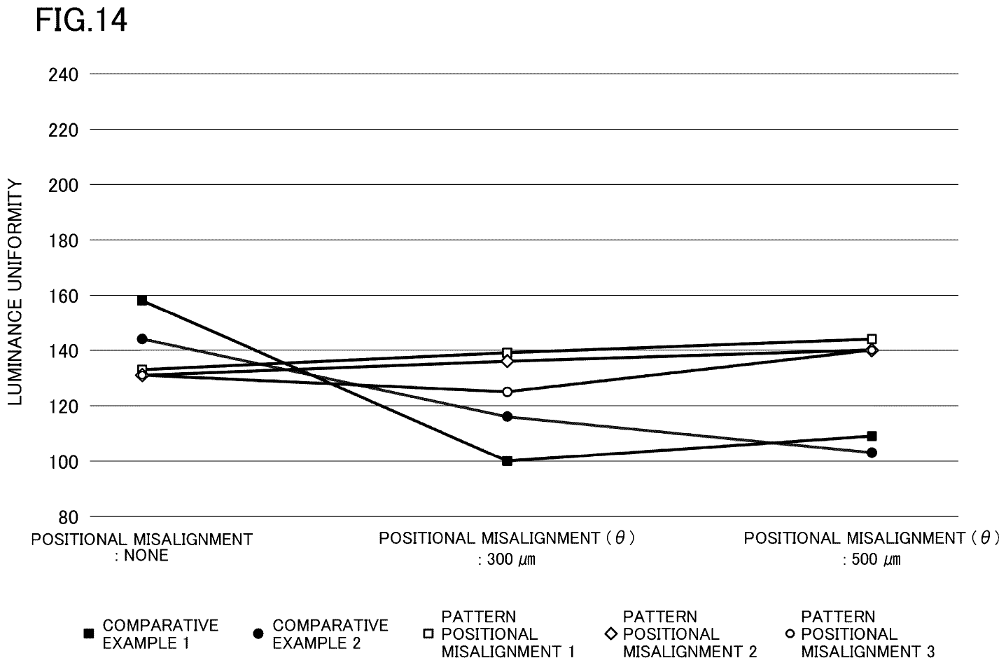

FIG. 14 and Table 1 show results of evaluation of how positional misalignment of the print patterns in the evaluation samples of Example and Comparative Examples affects the luminance uniformity.

TABLE 1

| | | | A plurality of print | | |
|---|---|---|---|---|---|
| | Single print pattern | | patterns (Example) | | |
| | (Comparative Example) | | Pattern | Pattern | Pattern |
| | Comparative | Comparative | Positional | Positional | Positional |
| | Example 1 | Example 2 | Misalignment 1 | Misalignment 2 | Misalignment 3 |
| Positional Misalignment: None | 158 | 144 | 133 | 131 | 131 |
| Positional Misalignment (θ): 300 μm | 100 | 116 | 139 | 136 | 125 |
| Positional Misalignment (θ): 500 μm | 109 | 103 | 144 | 140 | 140 |

As shown in FIG. 14 and Table 1, in any of the pattern positional misalignments 1 to 3 in Example, the luminance uniformity was hardly reduced as compared to that without the positional misalignment. In contrast, in the positional misalignment of both 300 μm and 500 μm in the θ direction in Comparative Examples, the luminance uniformity was significantly reduced as compared to that without the positional misalignment.

From the above results, it has been found that, since the luminance unevenness is reduced by combination of the plurality of print patterns 101A and 101B as shown in Example, the luminance uniformity can be less reduced even when the positions of the plurality of print patterns 101A and 101B are misaligned, as compared to that with the single print pattern 101 as shown in Comparative Example.

### Other Embodiments

The above describes embodiments (including examples; the same applies hereinafter) of the present disclosure. However, the present disclosure is not limited only to the aforementioned embodiments, and various modifications are possible within the scope of the disclosure. That is, the above description of the embodiments is solely to serve as an example in nature, and is not intended to limit the present disclosure, applications thereof, or uses thereof.

1. An optical sheet laminate built in a liquid crystal display device including a display screen, on a back surface side of which a plurality of point light sources are provided in a dispersed manner, comprising:
a first optical sheet comprising a first surface on which a first print pattern at least partially reducing transmission of light from the plurality of point light sources is formed, wherein
a second print pattern at least partially reducing transmission of light from the plurality of point light sources is formed on a second optical sheet different from the first optical sheet or on a second surface of the first optical sheet, and
the first print pattern and the second print pattern reduce luminance unevenness attributed to the plurality of point light sources, thereby making the luminance uniform.

2. The optical sheet laminate of claim 1, wherein
the first print pattern and the second print pattern are each a collection of unit patterns arranged in a gradation manner so that a level of reduction in light transmission decreases from a vicinity of a portion directly above one single point light source out of the plurality of point light sources toward an intermediate region between the one single point light source and another point light source adjacent to the one single point light source, and the unit patterns are arranged two-dimensionally without uneven distribution to serve as the first print pattern and the second print pattern.

3. The optical sheet laminate of claim 1, wherein
at least one of the first print pattern or the second print pattern is a pattern comprising a print density corresponding to luminance in a luminance distribution produced by the plurality of point light sources when the first print pattern and the second print pattern are not provided, and the luminance and the print density have a positive correlation with each other.

4. The optical sheet laminate of claim 1, wherein
a pattern formed by stacking the first print pattern and the second print patterns is a pattern comprising a print density corresponding to luminance in a luminance distribution produced by the plurality of point light sources when the first print pattern and the second print pattern are not provided, and the luminance and the print density have a positive correlation with each other.

5. The optical sheet laminate of claim 3, wherein
a high luminance region in the luminance distribution is a region directly above the plurality of point light sources.

6. The optical sheet laminate of claim 3, wherein
a high luminance region in the luminance distribution is a region between point light sources adjacent to each other out of the plurality of point light sources.

7. The light optical sheet laminate of claim 1, wherein
the first optical sheet is a first light diffusion sheet.

8. The optical sheet laminate of claim 7, wherein
the second print pattern is formed on the second optical sheet,
in the first light diffusion sheet, the first surface is a flat surface or a matte surface, and the second surface comprises a plurality of recesses arranged two-dimensionally, and
the second optical sheet is a second light diffusion sheet comprising a flat surface or a matte surface on which the second print pattern is formed.

9. The optical sheet laminate of claim 7, wherein
the second print pattern is formed on the first light diffusion sheet, and
in the first light diffusion sheet, one of the first surface or the second surface comprises a plurality of recesses arranged two-dimensionally, and the other one of the first surface or the second surface is a flat surface or a matte surface.

10. The optical sheet laminate of claim 8, wherein
the plurality of recesses comprise an inverted polygon pyramid shape, an inverted truncated polygon pyramid shape, or a lower hemisphere shape.

11. A backlight unit built in the liquid crystal display device and leading light emitted from the plurality of point light sources toward the display screen, comprising:
the optical sheet laminate of claim 1 between the display screen and the plurality of point light sources.

12. The backlight unit of claim 11, wherein
a distance between the plurality of point light sources and the optical sheet laminate is 2 mm or less.

13. The backlight unit of claim 11, wherein
the plurality of point light sources are LED elements.

14. The backlight unit of claim 11, wherein
the plurality of point light sources are arranged on a reflection member provided on an opposite side of the display screen when viewed from the optical sheet laminate.

15. A liquid crystal display device, comprising:
the backlight unit of claim 11; and
a liquid crystal display panel.

16. An information equipment, comprising:
the liquid crystal display device of claim 15.

17. A production method for an optical sheet laminate built in a liquid crystal display device including a display screen, on a back surface side of which a plurality of point light sources are provided in a dispersed manner, comprising:
a step A of forming a first print pattern at least partially reducing transmission of light from the plurality of point light sources, on a first surface of a first optical sheet; and
a step B of forming a second print pattern at least partially reducing transmission of light from the plurality of point light sources, on a second optical sheet different from the first optical sheet or on a second surface of the first optical sheet, wherein
the step A and the step B are performed so that the first print pattern and the second print pattern reduce luminance unevenness attributed to the plurality of point light sources, thereby making the luminance uniform.

18. The method of claim 17, wherein
the first print pattern and the second print pattern are each a collection of unit patterns arranged in a gradation manner so that a level of reduction in light transmission decreases from a vicinity of a portion directly above one single point light source out of the plurality of point light sources toward an intermediate region between the one single point light source and another point light source adjacent to the one single point light source, and the unit patterns are arranged two-dimensionally without uneven distribution to serve as the first print pattern and the second print pattern.

19. The method of claim 17, wherein
at least one of the first print pattern or the second print pattern is a pattern comprising a print density corresponding to luminance in a luminance distribution produced by the plurality of point light sources when the first print pattern and the second print pattern are not provided, and the luminance and the print density have a positive correlation with each other.

20. The method of claim 17, wherein
a pattern formed by stacking the first print pattern and the second print patterns is a pattern comprising a print density corresponding to luminance in a luminance distribution produced by the plurality of point light sources when the first print pattern and the second print pattern are not provided, and the luminance and the print density have a positive correlation with each other.

21. The method of claim 19, wherein
a high luminance region in the luminance distribution is a region directly above the plurality of point light sources.

22. The method of claim 19, wherein
a high luminance region in the luminance distribution is a region between point light sources adjacent to each other out of the plurality of point light sources.
